(19) United States
(12) Patent Application Publication
(10) Pub. No.: US 2024/0188123 A1
(43) Pub. Date: Jun. 6, 2024

(54) METHOD FOR TRANSMITTING ANISOCHRONOUS PACKET IN TIME SENSITIVE WIRELESS NETWORK

(71) Applicant: ELECTRONICS AND TELECOMMUNICATIONS RESEARCH INSTITUTE, Daejeon (KR)

(72) Inventors: Jae Sun CHA, Daejeon (KR); Eun Hee KIM, Daejeon (KR); Tae Joon PARK, Daejeon (KR); Kye Seon LEE, Daejeon (KR)

(21) Appl. No.: 18/526,211

(22) Filed: Dec. 1, 2023

(30) Foreign Application Priority Data
Dec. 2, 2022 (KR) 10-2022-0166738
Jul. 31, 2023 (KR) 10-2023-0099696

(51) Int. Cl. H04W 74/08

(52) U.S. Cl. CPC H04W 74/08

(57) ABSTRACT

Provided is a method of transmitting an anisochronous packet between devices in a time-sensitive wireless network. The method includes determining whether a whole packet to be transmitted is transmittable within a residual time of a contention period (CP), when the whole packet to be transmitted is not transmittable within the residual time of the CP, segmenting the packet to be transmitted into packet fragments with a length which is transmittable within the residual time of the CP, adding packet fragment information to the packet fragments, and transmitting one of the packet fragments within the residual time of the CP.

### CROSS-REFERENCE TO RELATED APPLICATIONS

This application claims priority to and the benefit of Korean Patent Application No. 10-2022-0166738, filed on Dec. 2, 2022 and Korean Patent Application No. 10-2023-0099696, filed on Jul. 31, 2023, which are hereby incorporated by reference for all purposes as if set forth herein.

### BACKGROUND

### 1. Field of the Invention

The present invention relates to wireless network technology, and more particularly, to a method of efficiently transmitting an anisochronous packet in a time-sensitive wireless network.

### 2. Description of Related Art

Time-sensitive network technology is network infrastructure technology for deterministic packet transmission of time-sensitive critical mission service traffic.

Here, deterministic packet transmission is an operation of transmitting packets with transmission delay times and a transmission delay deviation not exceeding limited ranges and is a very important requirement of the industrial automation field. In particular, an isochronous service provided through a control loop system should satisfy requirements of a very short transmission delay time (≤1 ms) and a transmission delay deviation (≤1 μs).

Meanwhile, a time-sensitive network may be run in connection with not only a control loop system but also various industrial application systems, such as a process status report system, a closed-circuit television (CCTV) system, an automated guided vehicle (AGV) system, and the like. Requirements to be satisfied may vary depending on service characteristics provided by application systems.

For example, while an isochronous service provided by a control loop system requires a very limited transmission delay and transmission delay deviation, a CCTV or AGV service requires a slightly limited transmission delay and transmission delay deviation, and a process status report service may not require any transmission delay or transmission delay deviation.

In a time-sensitive wireless network in which several devices share a wireless channel to transmit packets generated from various types of services, transmission of a packet generated from a specific service may interrupt transmission of another service packet, resulting in quality degradation of the service.

For example, transmission time points of isochronous service packets whose transmission delay times and transmission delay deviation are very important performance indicators are scheduled in advance, and the isochronous packets are transmitted at the scheduled time point. When transmission of an anisochronous packet which has been generated earlier than a scheduled transmission time point of an isochronous service packet is finished later than the scheduled time point, transmission of the isochronous service packet may be delayed beyond the schedule time point or may not be started. In this case, the requirements of a transmission delay time and a transmission delay deviation are not satisfied, which may lead to quality degradation of an application service or a system operation error.

When there is an isochronous service packet which is scheduled for transmission, to prevent transmission delay of the packet, transmission of anisochronous packets may be stopped until transmission of the isochronous packet is started. In this case, however, it is not possible to use the wireless channel until transmission of the isochronous packet is started, and as a result, efficiency of the overall system is degraded.

### SUMMARY OF THE INVENTION

The present invention is directed to providing an anisochronous packet transmission method for increasing transmission efficiency of an anisochronous packet without degrading the quality of an isochronous service in a time-sensitive wireless network.

According to an aspect of the present invention, there is provided a method of transmitting an anisochronous packet between devices in a time-sensitive wireless network, the method including determining whether a whole packet to be transmitted is transmittable within a residual time of a contention period (CP), when the whole packet to be transmitted is not transmittable within the residual time of the CP, segmenting the packet to be transmitted into packet fragments with a length which is transmittable within the residual time of the CP, adding packet fragment information to the packet fragments, and transmitting one of the packet fragments within the residual time of the CP.

The method may further include, before the determining of whether the whole packet to be transmitted is transmittable within the residual time of the CP, comparing the residual time of the CP with a minimum time required for transmitting the packet to determine whether the packet is transmittable.

The minimum time required for transmitting the packet may be a time required for transmitting a header and an error correction code of the packet.

The determining of whether the whole packet to be transmitted is transmittable within the residual time of the CP may comprise comparing a time required for transmitting the whole packet to be transmitted with the residual time of the CP.

The segmenting of the packet to be transmitted into the packet fragments with the length which is transmittable within the residual time of the CP may comprise generating a packet fragment with a maximum size which is transmittable within the residual time of the CP.

A margin value may be applied to the packet fragment with the maximum size.

The packet fragment information may include a parameter representing whether there is an additional packet fragment and a parameter representing a position number of the packet fragment.

In the packet fragment information, the parameter representing the position number of the packet fragment may not be changed when the packet fragment is retransmitted.

The packet fragment information may be included in a header of the packet fragment.

The time-sensitive wireless network may have a frame structure divided into a contention-free period (CFP) for transmitting an isochronous packet and a CP for transmitting an anisochronous packet.

According to another aspect of the present invention, there is provided a method of transmitting an anisochronous packet, the method including, when a transmission request for an anisochronous packet is generated, determining whether the whole anisochronous packet is transmittable within a residual time of a CP, when the whole anisochronous packet is not transmittable within the residual time of the CP, segmenting the anisochronous packet into a first packet fragment and a second packet fragment, transmitting the first packet fragment within the residual time of the CP, and when a transmission request for the second packet fragment is generated in a follow-up CP, determining whether the whole second packet fragment is transmittable within a residual time of the follow-up CP and segmenting or transmitting the second packet fragment.

The method may further include, before the transmitting of the first packet fragment within the residual time of the CP, adding packet fragment information to the first packet fragment.

The first packet fragment may have a length which is transmittable within the residual time of the CP.

The segmenting or transmitting of the second packet fragment may include, when the whole second packet fragment is not transmittable within the residual time of the follow-up CP, segmenting the second packet fragment into a third packet fragment and a fourth packet fragment and transmitting the third packet fragment.

The segmenting or transmitting of the second packet fragment may include, when the whole second packet fragment is transmittable within the residual time of the follow-up CP, transmitting the second packet fragment.

According to another aspect of the present invention, there is provided a method of transmitting an anisochronous packet, the method including determining whether a whole packet to be transmitted is transmittable within a residual time of a CP, when the whole packet to be transmitted is not transmittable within the residual time of the CP, segmenting the packet to be transmitted into packet fragments, and transmitting one of the packet fragments within the residual time of the CP.

The method may further include, before the transmitting of the one of the packet fragments within the residual time of the CP, adding packet fragment information to the packet fragments.

The method may further include, when the whole packet to be transmitted is transmittable within the residual time of the CP, transmitting the packet to be transmitted.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a time-sensitive wireless network according to an exemplary embodiment of the present invention;

FIG. 2 is a diagram illustrating a wireless frame structure of a time-sensitive wireless network according to an exemplary embodiment of the present invention;

FIG. 3 is a diagram illustrating a case where the transmission quality of an isochronous packet is degraded due to the transmission of an anisochronous packet;

FIG. 4 is a diagram illustrating an inefficient anisochronous packet transmission method according to an exemplary embodiment of the present invention;

FIG. 5 is a flowchart illustrating a method of transmitting an anisochronous packet in a time-sensitive wireless network according to an exemplary embodiment of the present invention; and

FIG. 6 is a diagram illustrating transmission of anisochronous packets in a method of transmitting an anisochronous packet in a time-sensitive wireless network according to an exemplary embodiment of the present invention.

### DETAILED DESCRIPTION OF EXEMPLARY EMBODIMENTS

Hereinafter, a method of transmitting an anisochronous packet in a time-sensitive wireless network according to an exemplary embodiment of the present invention will be described with reference to the accompanying drawings. In this process, the thicknesses of lines, the sizes of components, and the like shown in the drawings may be exaggerated for the purpose of clarity and convenience of description. Also, terms to be described below are defined in consideration of functions in the present invention, and the terms may vary depending on the intention of a user or operator or precedents. Therefore, the definitions of these terms are to be made on the basis of the overall content of the specification.

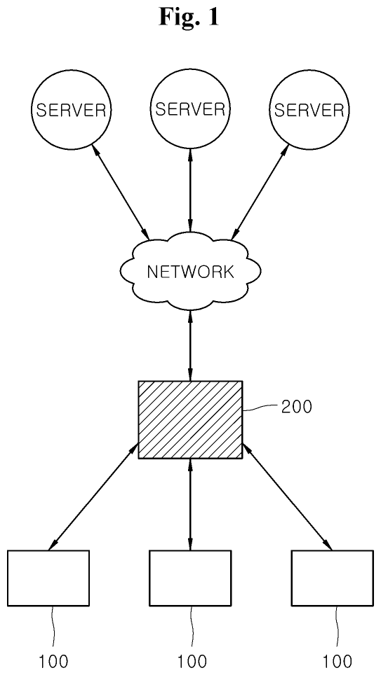

FIG. 1 is a block diagram illustrating a time-sensitive wireless network according to an exemplary embodiment of the present invention.

Referring to FIG. 1, a time-sensitive wireless network may include an access point 200 and one or more end devices 100.

The access point 200 is a device in charge of managing the time-sensitive wireless network including the plurality of end devices 100 and may be connected to an application server or another network through a wired or wireless interface.

The end devices 100 are connected to a time-sensitive network such as an industrial automation controller (IAC) network, a sensor network, a driving device network, a tablet network, an automated guided vehicle (AGV) network, and the like and take charge of wirelessly transmitting and receiving data generated by an application device for providing a specific service.

For example, data measured by a sensor may be transmitted to the IAC through the end device 100 and the access point 200, and data generated by the IAC may be transmitted to a driving device so that the driving device is controlled. Also, image data captured by a tablet may be passed through the end device 100 and the access point 200 and transmitted to a server in charge of a specific application service, and coordinate data generated by a server for controlling an AGV may be passed through the access point 200 and the end device 100, transmitted to the AGV, and used for controlling the location of the AGV.

The end devices 100 and the access point 200 may be referred to as wireless network devices.

Also, all of the end devices 100 and the access point 200 may be wireless local area network (LAN) devices, which may include a medium access control (MAC) layer, a physical (PHY) layer, and the like according to the Institute of Electrical and Electronics Engineers (IEEE) 802.11 standard.

The end devices 100 and the access point 200 may be referred to as nodes, and the end devices 100 other than an access point may be referred to as stations.

Each of the end devices 100 and the access point 200 may include a controller, a memory, and a transmission and reception device. The controller may be a processor. The processor may implement operations of an anisochronous packet transmission method to be described below. Instructions for implementing these operations may be stored in the memory.

The transmission and reception device may be implemented as a transceiver or the like to transmit and receive wireless signals and, for example, a PHY layer of IEEE 802.11 may be implemented.

The processor and/or transceiver may include an application-specific integrated circuit (ASIC), another chipset, a logic circuit, and/or a data processing device. The memory may be a read-only memory (ROM), a random access memory (RAM), a flash memory, a memory card, a storage medium, and/or another storage device. When the exemplary embodiment is implemented as software, operations according to the present invention may be implemented as modules (processes, functions, and the like) for performing functions. The modules may be stored in the memory and executed by the processor. The memory may be present in or outside the processor or connected to the processor in various ways.

Various types of application devices are connected to the time-sensitive wireless network and provide services. Accordingly, requirements of packets transmitted between the access point 200 and the end devices 100 may vary depending on service characteristics.

For example, packets exchanged between the sensor, the driving device, and the IAC for automation control of a specific manufacturing process are isochronous packets requiring strict periodicity and determinacy. All the packets are required to be transmitted or received within a limited delay time and delay time deviation.

On the other hand, image data generated by the tablet or data for location control of the AGV is required to be transmitted in real time, but the requirement is less strict than those of isochronous packets and is supportable by a general wireless network other than a time-sensitive network. The tablet may transmit not only image data but also non-real-time data such as a safety check result, an inventory stock report, or the like. Data transmitted in this case has no time-related requirement and is best effort packets that merely require transmission.

In the present invention, all service packets that have no requirements for a delay time and a delay time deviation which are required by real-time or best effort packets are referred to as anisochronous packets.

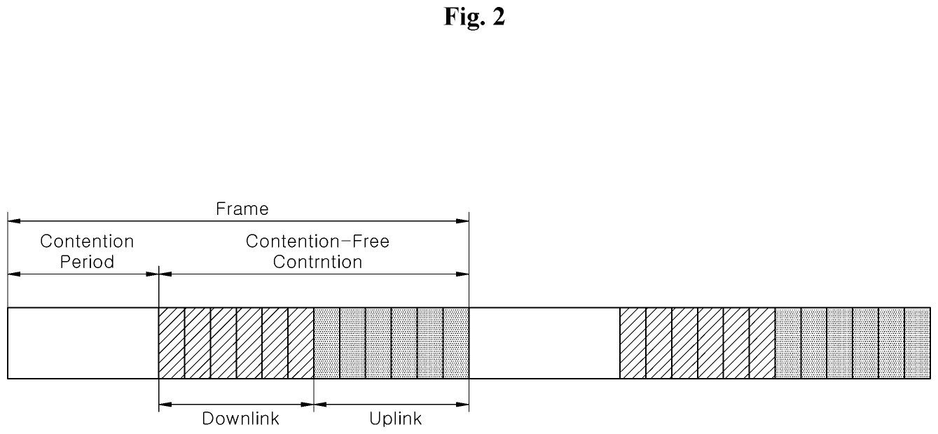

FIG. 2 is a diagram illustrating a wireless frame structure of a time-sensitive wireless network according to an exemplary embodiment of the present invention.

As shown in FIG. 2, in a time-sensitive network, a wireless frame may be divided into two periods to ensure the service quality of isochronous packets.

A contention-free period (CFP) is a period for transmitting isochronous packets, and a method of transmitting data through a pre-allocated slot is applied thereto. Isochronous packets are transmitted at a predetermined time point (e.g., a slot) without contention.

On the other hand, a contention period (CP) is a period for transmitting an anisochronous packet, and a method of acquiring resources in a competitive manner and transmitting packets is applied thereto. The access point 200 or the end device 100 that wants to transmit data may acquire wireless resources first in a competitive manner and then transmit packets through the acquired wireless resources.

For example, in the CP, the access point 200 or the end device 100 may be allocated a slot for transmitting a packet on the basis of carrier sense multiple access/collision avoidance (CSMA/CA) multiple access technology.

In the case of transmitting anisochronous packets in a CP (i.e., when an anisochronous packet to be transmitted is generated in the CP), the access point 200 or the end device 100 may perform operations according to the anisochronous packet transmission method to be described below.

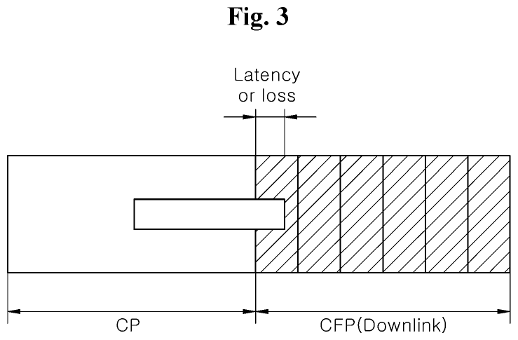

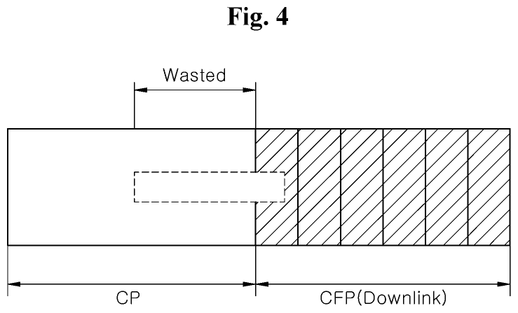

FIG. 3 is a diagram illustrating a case where the transmission quality of an isochronous packet is degraded due to the transmission of an anisochronous packet, and FIG. 4 is a diagram illustrating an inefficient anisochronous packet transmission method according to an exemplary embodiment of the present invention.

FIG. 3 shows a case where transmission of an anisochronous packet which is started before the end of a CP is not finished within the CP and invades a CFP. In this case, transmission of an isochronous packet scheduled in the first slot of the CFP is delayed until the transmission of the anisochronous packet that was started earlier is finished. When the transmission of the anisochronous packet is finished in the second slot of the CFP, the isochronous packet of which transmission has been scheduled in the first slot is not transmitted and is discarded. Also, transmission of the next slot may also be delayed due to the transmission delay occurring in the first slot, and as a result, transmission of all isochronous packets may be delayed or interrupted.

FIG. 4 shows a case of delaying transmission of an anisochronous packet until a CP to prevent quality degradation of an isochronous packet when it is necessary to transmit the anisochronous packet after a specific critical time point before the previous CP ends. In this case, it is possible to prevent transmission delay of the isochronous packet by delaying transmission of the anisochronous packet until the next CP. However, packet transmission is intentionally stopped until a time point at which a CFP starts. Accordingly, the corresponding wireless resources may be wasted without being used, and the amount of wasted wireless resources may increase according to the critical time point for determining transmission delay of the anisochronous packet.

On the other hand, according to the anisochronous packet transmission method of the present invention, when an anisochronous packet to be transmitted is generated within a CP, it is determined whether to transmit the anisochronous packet on the basis of a current residual time of the CP, and when it is determined that a part of the anisochronous packet is transmittable within the residual time of the CP, the anisochronous packet is segmented and transmitted. Accordingly, the anisochronous packet can be transmitted without interrupting isochronous packets, and as much time allocated to transmit anisochronous traffic as possible is used. As a result, system efficiency can be improved by maximizing utilization of wireless resources.

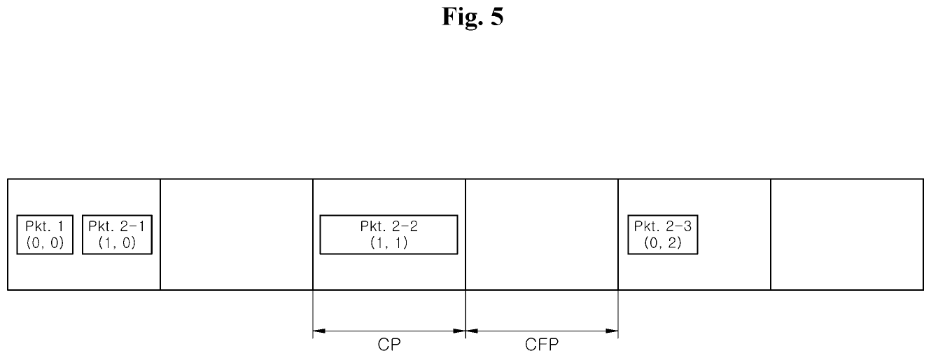

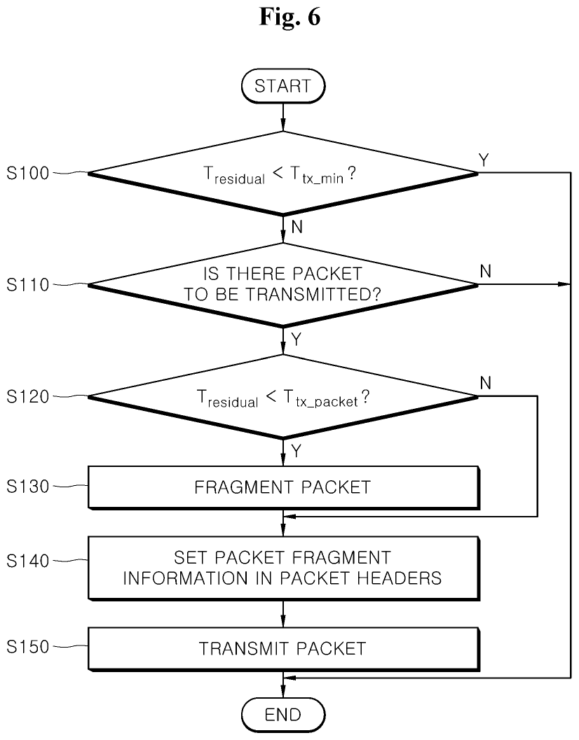

FIG. 5 is a flowchart illustrating a method of transmitting an anisochronous packet in a time-sensitive wireless network according to an exemplary embodiment of the present invention, and FIG. 6 is a diagram illustrating transmission of anisochronous packets in a method of transmitting an anisochronous packet in a time-sensitive wireless network according to an exemplary embodiment of the present invention.

As shown in FIG. 5, when an anisochronous packet transmission procedure is started in a CP, the access point 200 or the end device 100 compares a current residual time T_{residual} of the CP with a minimum time T_{tx_min} required for packet transmission (S100). Since general packets and packet fragments of the present invention include a header and an error correction code (e.g., a cyclic redundancy check (CRC) code), a minimum time required for packet transmission may be a time required for transmitting a header and an error correction code.

When the current residual time T_{residual} of the CP is shorter than the minimum time T_{tx_min} required for packet transmission (yes at S100), there is no anisochronous packet that can be transmitted within the residual time. Accordingly, the anisochronous packet transmission procedure ends regardless of the current residual time T_{residual} of the CP.

When the current residual time T_{residual} of the CP is longer than the minimum time T_{tx_min} required for packet transmission (no in S100) and there is an anisochronous packet to be transmitted (yes in S110), the current residual time T_{residual} of the CP is compared with a time T_{tx_packet} required for transmitting the anisochronous packet to be transmitted (S120).

When the current residual time T_{residual} of the CP is shorter than the time T_{tx_packet} required for transmitting the anisochronous packet to be transmitted (yes in S120), the whole anisochronous packet is not transmittable during the residual time. Accordingly, the anisochronous packet is segmented in transmittable length units (S130).

For example, a packet fragment having a maximum size which is transmittable within the current residual time T_{residual} of the CP may be generated. In some embodiments, a packet fragment may include a header, transmission data, and an error correction code, and thus a packet fragment may be generated with a maximum size which is transmittable within a time calculated by subtracting a time required for transmitting a header and an error correction code from the residual time T_{residual} of the CP. In other words, the maximum size may be determined according to a data transmission rate and a time in which data transmission is allowed.

In some embodiments, a margin value may be applied to transmission data of the maximum size to prevent a transmission error. For example, when there is a time in which data of 20 bytes is transmittable, a packet fragment for transmitting only 19 bytes may be generated using one byte as a margin value.

In some embodiments, a margin value may be applied to the current residual time T_{residual} of the CP and/or the time calculated by subtracting the time required for transmitting the header and the error correction code from the current residual time T_{residual} of the CP in the same way that a margin value is applied to transmission data.

In some embodiments, the time calculated by subtracting the time required for transmitting the header and the error correction code from the current residual time T_{residual} of the CP may be a value calculated by subtracting the minimum time T_{tx_min} required for packet transmission from the current residual time T_{residual} of the CP.

Subsequently, packet fragment information is set in headers of the segmented packet (S140).

The packet fragment information may include a parameter (More Fragment) used for representing that a currently transmitted packet fragment is the last or unique fragment and a parameter (Fragment Number) representing the position number of a packet fragment.

The parameter (More Fragment) used for representing that a currently transmitted packet fragment is the last or unique fragment may be set to a first value (e.g., 1) when an additional (other) packet fragment corresponds to the current packet, and may be set to a second value (e.g., 0) when the current packet fragment is the last fragment corresponding to the packet or includes the whole packet. When a packet fragment is initially transmitted, an additional packet fragment may exist, but after the additional packet fragment is retransmitted, the packet fragment may have already been transmitted. Accordingly, More Fragment may be changed in consideration of whether an additional packet fragment to be transmitted currently exists when the packet fragment is retransmitted.

In the case of the parameter (Fragment Number) representing the position number of a packet fragment, Fragment Number of a first packet fragment of the packet may be set to an initial value (e.g., 0), and Fragment Number may increase by one for each of subsequent consecutive packet fragments. Fragment Number does not change when the corresponding packet fragment is retransmitted.

Subsequently, the access point 200 or the end device 100 transmits the packet (packet fragments) (S150).

In the subsequent operation, the operations of FIG. 5 described above may be repeated. In other words, a process of determining whether a whole packet (packet fragment) to be transmitted is transmittable within a residual time of a CP, and when the whole packet (packet fragment) is not transmittable, segmenting the packet (packet fragment) and transmitting the packet (packet fragment) may be repeated. This process may be continuously repeated when a CP is started and there is a packet to be transmitted.

In the present invention, packet fragments may also be considered packets to be transmitted.

Meanwhile, a receiving side may assemble the received packet fragments with reference to the fragment information included in the packet fragments. In other words, it may be determined whether all segmented packet parts are received with reference to the packet fragment information, and when all the segmented packet parts are received, the segmented packet parts may be assembled into a packet.

In some embodiments, when a transmission request for an anisochronous packet is generated, it may be determined whether the whole anisochronous packet is transmittable within a residual time of a CP. When the whole anisochronous packet is not transmittable within the residual time of the CP, the anisochronous packet may be segmented into a first packet fragment and a second packet fragment, and then the first packet fragment may be transmitted within the residual time of the CP.

When a transmission request for the second packet fragment is generated in a follow-up CP, it may be determined whether the whole second packet fragment is transmittable within a residual time of the follow-up CP. When the whole second packet fragment is not transmittable within the residual time of the follow-up CP, the second packet fragment may be segmented into a third packet fragment and a fourth packet fragment. In this case, the third packet fragment may be transmitted, and it may be determined whether the fourth packet fragment is transmittable in the subsequent CP.

Meanwhile, when the whole second packet fragment is transmittable within the residual time of the follow-up CP, the second packet fragment may be transmitted within the residual time of the follow-up CP.

Referring to FIG. 6, a whole first anisochronous packet Pkt. 1 is transmittable within a residual CP. In this case, the anisochronous packet is transmitted according to the related art. However, to notify that the currently transmitted anisochronous packet is a whole packet which has not been processed, both of the parameters More Fragment and Fragment Number are set to 0 and transmitted.

The second transmission of FIG. 6 corresponds to a case where a whole anisochronous packet is not transmittable within a residual CP. In this case, the packet is segmented in length units that are transmittable within the residual CP, and then a first packet fragment Pkt. 2-1 is transmitted. Since a currently transmitted packet fragment is the first packet fragment and transmission of a second packet fragment is scheduled later, fragment information is set to (1, 0).

The third transmission of FIG. 6 corresponds to a case where a residual packet fragment which has not been transmitted in the previous CP is transmitted but the whole residual packet fragment is not transmittable within a CP. In this case, like in the second transmission, the residual packet fragment is segmented, and then a corresponding packet fragment Pkt. 2-2 is transmitted with fragment information set to (1, 1). The fragment information (1, 1) represents that the currently transmitted packet fragment Pkt. 2-2 is the second packet fragment and a third packet fragment is scheduled for transmission.

The last transmission of FIG. 6 corresponds to a case where a residual packet fragment which has not been transmitted in the previous CP is transmitted and the whole residual packet fragment is transmittable within a CP. In this case, fragment information is set to (0, 2) to notify that the residual packet fragment is the third packet fragment and also is the last packet fragment, and the whole residual packet fragment is transmitted.

As described above, with a method of transmitting an anisochronous packet in a time-sensitive wireless network according to an exemplary embodiment of the present invention, it is possible to transmit anisochronous traffic in a time-sensitive wireless network without interrupting transmission of isochronous traffic or performance degradation, and as much time allocated to transmit anisochronous traffic as possible is used. Therefore, system efficiency can be improved by maximizing utilization of wireless resources.

According to an anisochronous packet transmission method of the present invention, whether a whole anisochronous packet is transmittable within a CP is determined to perform segmentation. Accordingly, it is possible to use as much time allocated for anisochronous traffic transmission as possible.

According to the anisochronous packet transmission method of the present invention, an anisochronous packet is transmitted within a CP without interrupting a CFP. Accordingly, the anisochronous packet can be transmitted without interruption of anisochronous traffic transmission or performance degradation.

Although the present invention has been described above with reference to embodiments illustrated in the drawings, the embodiments are merely illustrative, and those skilled in the art should understand that various modifications and other equivalent embodiments can be made from the embodiments. Therefore, the technical scope of the present invention should be determined from the following claims.

What is claimed is:

1. A method of transmitting an anisochronous packet between devices in a time-sensitive wireless network, the method comprising:
determining whether a whole packet to be transmitted is transmittable within a residual time of a contention period (CP);
when the whole packet to be transmitted is not transmittable within the residual time of the CP, segmenting the packet to be transmitted into packet fragments with a length which is transmittable within the residual time of the CP;
adding packet fragment information to the packet fragments; and
transmitting one of the packet fragments within the residual time of the CP.

2. The method of claim 1, further comprising, before the determining of whether the whole packet to be transmitted is transmittable within the residual time of the CP, comparing the residual time of the CP with a minimum time required for transmitting the packet to determine whether the packet is transmittable.

3. The method of claim 2, wherein the minimum time required for transmitting the packet is a time required for transmitting a header and an error correction code of the packet.

4. The method of claim 1, wherein the determining of whether the whole packet to be transmitted is transmittable within the residual time of the CP comprises comparing a time required for transmitting the whole packet to be transmitted with the residual time of the CP.

5. The method of claim 1, wherein the segmenting of the packet to be transmitted into the packet fragments with the length which is transmittable within the residual time of the CP comprises generating a packet fragment with a maximum size which is transmittable within the residual time of the CP.

6. The method of claim 5, wherein a margin value is applied to the packet fragment with the maximum size.

7. The method of claim 1, wherein the packet fragment information includes:
a parameter representing whether there is an additional packet fragment; and
a parameter representing a position number of the packet fragment.

8. The method of claim 7, wherein, in the packet fragment information, the parameter representing the position number of packet fragment is not changed when the packet fragment is retransmitted.

9. The method of claim 1, wherein the packet fragment information is included in a header of the packet fragment.

10. The method of claim 1, wherein the time-sensitive wireless network has a frame structure divided into a contention-free period (CFP) for transmitting an isochronous packet and a CP for transmitting an anisochronous packet.

11. A method of transmitting an anisochronous packet, the method comprising:
when a transmission request for an anisochronous packet is generated, determining whether the whole anisochronous packet is transmittable within a residual time of a contention period (CP);
when the whole anisochronous packet is not transmittable within the residual time of the CP, segmenting the anisochronous packet into a first packet fragment and a second packet fragment;
transmitting the first packet fragment within the residual time of the CP; and
when a transmission request for the second packet fragment is generated in a follow-up CP, determining whether the whole second packet fragment is transmittable within a residual time of the follow-up CP and segmenting or transmitting the second packet fragment.

12. The method of claim 11, further comprising, before the transmitting of the first packet fragment within the residual time of the CP, adding packet fragment information to the first packet fragment.

13. The method of claim 12, wherein the packet fragment information includes:
a parameter representing whether there is an additional packet fragment; and
a parameter representing a position number of the packet fragment.

14. The method of claim 11, wherein the first packet fragment has a length which is transmittable within the residual time of the CP.

15. The method of claim 11, wherein the segmenting or transmitting of the second packet fragment comprises, when the whole second packet fragment is not transmittable within the residual time of the follow-up CP, segmenting the second packet fragment into a third packet fragment and a fourth packet fragment and transmitting the third packet fragment.

16. The method of claim 11, wherein the segmenting or transmitting of the second packet fragment comprises, when the whole second packet fragment is transmittable within the residual time of the follow-up CP, transmitting the second packet fragment.

17. A method of transmitting an anisochronous packet, the method comprising:
determining whether a whole packet to be transmitted is transmittable within a residual time of a contention period (CP);
when the whole packet to be transmitted is not transmittable within the residual time of the CP, segmenting the packet to be transmitted into packet fragments; and
transmitting one of the packet fragments within the residual time of the CP.

18. The method of claim 17, further comprising, before the transmitting of the one of the packet fragments within the residual time of the CP, adding packet fragment information to the packet fragments.

19. The method of claim 18, wherein the packet fragment information includes:
a parameter representing whether there is an additional packet fragment; and
a parameter representing a position number of the packet fragment.

20. The method of claim 17, further comprising, when the whole packet to be transmitted is transmittable within the residual time of the CP, transmitting the packet to be transmitted.
